(19) United States
(12) Patent Application Publication
(10) Pub. No.: US 2021/0371108 A1
(43) Pub. Date: Dec. 2, 2021

(54) TOILET ARRANGEMENT FOR AN AIRCRAFT CABIN OF AN AIRCRAFT, AIRCRAFT HAVING THE TOILET ARRANGEMENT, AND METHOD FOR DRYING A STANDING SURFACE IN THE TOILET ARRANGEMENT

(71) Applicants: Diehl Aviation Laupheim GmbH, Laupheim (DE); Diehl Aerospace GmbH, Jeberlingen (DE)

(72) Inventors: Florian Zager-Rode, Buxtehude (DE); Tammo Bahns, Hamburg (DE); Lothar Trunk, Weibersbrunn (DE)

(21) Appl. No.: 17/333,273

(22) Filed: May 28, 2021

(30) Foreign Application Priority Data
May 28, 2020 (DE) 102020206713.9

(51) Int. Cl. B64D 11/02

(52) U.S. Cl. CPC B64D 11/02

(57) ABSTRACT

A toilet arrangement for an aircraft cabin of an aircraft having a cabin ventilation system for supplying the aircraft cabin with cabin air, includes at least one standing surface for cladding the toilet arrangement. The standing surface is disposed within the toilet arrangement. A ventilator has an entry interface for connection to the cabin ventilation system for transfer of the cabin air. An outlet element is connected to the entry interface for take-over of the cabin air. The ventilator generates a surface-air stream from the cabin air. The surface-air stream flows over the standing surface from the outlet element to dry the standing surface. An aircraft having the toilet arrangement and a method for drying a standing surface of the toilet arrangement are also provided.

### CROSS-REFERENCE TO RELATED APPLICATION

This application claims the priority, under 35 U.S.C. § 119, of German Patent Application DE 10 2020 206 713.9, filed May 28, 2020; the prior application is herewith incorporated by reference in its entirety.

### BACKGROUND OF THE INVENTION

### Field of the Invention

The invention relates to a toilet arrangement for an aircraft cabin of an aircraft having a cabin ventilation system for supplying the aircraft cabin with cabin air, the toilet arrangement having at least one standing surface disposed within the toilet arrangement for cladding the toilet arrangement, a ventilator having an entry interface for connection to the cabin ventilation system for transfer of the cabin air, and an outlet element connected to the entry interface for take-over of the cabin air. The invention also relates to an aircraft having the toilet arrangement and an aircraft cabin with a cabin ventilation system for supplying the aircraft cabin with cabin air. The invention further relates to a method for drying a standing surface in the toilet arrangement of the aircraft.

In aircraft, in particular in passenger aircraft, aircraft toilets form part of the facilities of an aircraft cabin for passengers. The aircraft toilets for shared use are often used to a great degree by the passengers during a flight, wherein the aircraft toilet provides different sanitary installation items, such as for example a washbasin and a toilet bowl, for use by the passengers. When the sanitary installation items are used, small quantities of liquid are deposited on the surfaces in the aircraft toilet due to splash water. High frequenting of the aircraft toilet by the passengers results in the accumulation of gradually increasing quantities of splash water as standing moisture. For example, the moisture builds up on the flooring. The flooring is soiled by the accumulated standing moisture and dirt particles brought into the aircraft toilet by the passengers, for example on their shoes, with the result that the aircraft toilet has to be laboriously cleaned by the on-board or ground personnel.

In that regard, suction-extraction systems for an aircraft toilet that suction moisture and dirt particles into a waste-collection container by using a connection to a vacuum toilet system of the aircraft toilet are known. In that case, German Patent Application DE 10 2018 002 896 A1 presents such an aircraft toilet with a flooring suction-extraction system. The aircraft toilet has side walls, a rear wall and a flooring element, as well as a toilet bowl which is disposed in the region of the rear wall. An apparatus for connection to a vacuum toilet system is provided in the region behind the rear wall for the toilet bowl, wherein the flooring suction-extraction system has a waste-collection container which is disposed below the toilet bowl and which includes at least one suction element, which suction element is oriented in the direction of the toilet interior so as to extract liquids and dirt particles from the flooring element by suction.

### BRIEF SUMMARY OF THE INVENTION

It is accordingly an object of the invention to provide a toilet arrangement for an aircraft cabin of an aircraft, an aircraft having the toilet arrangement and a method for drying a standing surface in the toilet arrangement, which overcome the hereinafore-mentioned disadvantages of the heretofore-known arrangements, aircrafts and methods of this general type and in which the toilet arrangement avoids accumulation of liquid in the toilet arrangement and reduces effort in the cleaning of the toilet arrangement by on-board or ground personnel.

With the foregoing and other objects in view there is provided, in accordance with the invention, a toilet arrangement for an aircraft cabin of an aircraft, in particular of a passenger aircraft. The aircraft has a cabin ventilation system for supplying the aircraft cabin with cabin air. The cabin ventilation system supplies the cabin air for example to a passenger seat in the aircraft cabin. The cabin ventilation system preferably has a supply network with a supply-air nozzle and an exhaust-air nozzle for the entire aircraft cabin. The aircraft cabin preferably has one or more monuments or cabin modules, such as for example an on-board kitchen (a so-called galley) or a rest compartment for on-board personnel (a so-called crew rest compartment), wherein these are jointly supplied with cabin air by the same cabin ventilation system. The toilet arrangement is preferably in the form of a toilet module and/or toilet monument and is integrated in the aircraft cabin or connected to the aircraft cabin. The toilet arrangement is preferably in the form of a room, and/or cubicle, which is accessible on foot, wherein the toilet arrangement preferably has multiple side walls, a rear wall, and a top and a base, and also a lockable door. Preferably, the toilet arrangement is connected to the cabin ventilation system for the purpose of ventilation. For example, the toilet arrangement has the supply-air and exhaust-air nozzles for supply with cabin air such that, in particular, “fresh air” flows into the toilet arrangement and “used air” flows out of the toilet arrangement. The toilet arrangement is preferably in the form of a wet cubicle and/or a wet room, which is connected to a water system of the aircraft for supplying fresh water to the toilet arrangement and for receiving wastewater. Basically, the toilet arrangement is constructed to be used by a passenger, for example for hygiene practices or for answering the call of nature.

The toilet arrangement has at least one standing surface for cladding the toilet arrangement. The standing surface is disposed within the toilet arrangement, in particular visibly within the interior of the toilet arrangement. The standing surface is preferably in the form of a surface for setting down items, for example in the form of a placement surface. As an alternative or optionally in addition, the standing surface is in the form of a surface which is accessible on foot and which serves for the standing and/or seating of passengers, for example in the form of a base surface or in the form of a seat surface. The standing surface is preferably formed so as to be level or at least with a slight inclination, so that passengers or items can be disposed in a stable manner thereon. The standing surface preferably has an arbitrary areal shape and areal extent, wherein the areal extent of the standing surface preferably measures at least 100 cm², preferably at least 500 cm², especially at least 1 m².

The toilet arrangement has a ventilator, wherein the ventilator has an entry interface for connection to the cabin ventilation system for take-over of the cabin air. The entry interface is preferably connected fluidically to the supply network of the cabin ventilation system such that the cabin air, in particular fresh air, is and/or can be extracted through the entry interface. In this way, the cabin air is and/or can be fed to the ventilator, wherein the ventilator is preferably constructed as a passive ventilator. Consequently, the ventilator uses an existing pressure of the cabin ventilation system for take-over of the cabin air. The entry interface is preferably in the form of an air connection, wherein the air connection is disposed so as to be guided outside the toilet arrangement for connection to the cabin ventilation system or to be disposed at the outside of the toilet arrangement. Preferably, the entry interface is constructed as a line connection. This is fluidically coupled to a line of the cabin ventilation system.

The toilet arrangement has an outlet element, wherein the outlet element is connected to the entry interface for take-over of the cabin air. The outlet element is connected in particular fluidically to the entry interface such that the cabin air extracted through the entry interface is and/or can be guided to the outlet element. This can be achieved in particular through a line. In other words, the entry interface and the outlet element can be connected by a line, in particular a tubular line, through which the cabin air can be or is guided from the entry interface to the outlet element. The outlet element is preferably in the form of an air nozzle and/or an air outlet. The outlet element preferably has an outlet opening which is in the form of a slot or a slit. The outlet opening is preferably formed to be at least 3 cm, preferably at least 5 cm, especially at least 15 cm or even at least 50 cm, wide. As an alternative or optionally in addition, the outlet element has multiple outlet openings which are formed in a line in a closely adjacent manner and/or lined up one next to the other. The outlet openings preferably have a combined total length of at least 15 cm, preferably of at least 50 cm. Preferably, in terms of its basic form, the outlet element is formed as a funnel or as a diffusor, wherein the outlet element has a narrowed inlet and an outlet which widens in a funnel-like manner.

According to the invention, it is provided that the ventilator generates a surface-air stream from the cabin air. The surface-air stream has in particular fresh air from the cabin ventilation system and/or is formed therefrom, wherein the surface-air stream flows into the toilet arrangement. The surface-air stream is preferably in the form of a concentrated air stream which extends in particular areally. For example, the surface-air stream has a width of at least 3 cm, preferably of at least 5 cm, especially of at least 15 cm or even at least 50 cm. The surface-air stream preferably has an air stream speed which results from the geometry of the outlet element and from a flow speed of the cabin air from the cabin ventilation system. The surface-air stream preferably has an air stream speed of at least 0.5 m/s, preferably of at least 1 m/s. It is furthermore provided that the surface-air stream flows over the standing surface from the outlet element in order to dry the standing surface. This is done, in particular, by the outlet element being directed towards the standing surface and thus directing or guiding the cabin air onto the standing surface. The surface-air stream preferably flows over the entire standing surface in such a way that the standing surface is dried in a uniform manner.

In particular when the toilet arrangement is used by the passengers, liquid, for example resulting from splash water, is deposited on the standing surface. The standing surface has for example liquid in the form of drops or in the form of a puddle, wherein the surface-air stream flows over the standing surface so that the liquid evaporates by way of the surface-air stream. In this way, the in particular “wet” standing surface is dried. Preferably, the evaporated liquid and/or moisture is extracted through an exhaust-air device for extracting used air of the toilet arrangement. For example, the exhaust-air device has one or more exhaust-air nozzles which are disposed at the top side in the toilet arrangement in order to suck in the moist used air. Preferably, the toilet arrangement has the exhaust-air device for extracting used air. As an alternative, the moist used air can be extracted by an exhaust-air device of the cabin ventilation system.

It is an advantage that, by way of the ventilator and the outlet element, provision is made for a toilet arrangement which uses already implemented system connections or system components in the aircraft (cabin ventilation system) to make simple and effective drying of standing surfaces in the toilet arrangement possible. In this way, a particularly inexpensive toilet arrangement with a drying function for standing surfaces is provided. The drying of the standing surface is promoted in particular by dry cabin air from the cabin ventilation system. The cabin ventilation system is, for example, configured to dehumidify the cabin air, wherein the cabin air preferably has a humidity of 20% or less. The dry cabin air promotes the evaporation of the liquid in the toilet arrangement, since it can absorb more moisture. It is advantageous if this moist used air can be and/or is capable of being returned to the cabin ventilation system for dehumidification. It is furthermore advantageous if, by way of the surface-air stream, continuous drying of the standing surfaces, for example of the flooring or of the placement surface, is possible, whereby for example formation of odors through liquid in the toilet arrangement is prevented and/or at least reduced. In this way, a toilet arrangement which is distinguished by a high level of comfort for the passengers is provided. It is moreover advantageous for the formation of standing moisture, which, for example, together with dirt particles, leads to quicker soiling of surfaces within the toilet arrangement, to be reduced or prevented. In this way, provision is made for a toilet arrangement for an aircraft cabin which is distinguished by little cleaning work by aircraft personnel.

In a preferred configuration of the invention, it is provided that the standing surface is formed horizontally in the toilet arrangement. In the aircraft cabin, “horizontal” is preferably to be understood as meaning that the standing surface is formed parallel to or so as to correspond to a cabin base over which the passengers and on-board personnel can move. The horizontal standing surface is disposed in such a manner that liquid can accumulate on the standing surface. It is conceivable for the standing surface to have an inclination with respect to the horizontal for the running-off of the liquid, but to still be able to be wetted with liquid. The surface-air stream is configured to dry the standing surface. Preferably, the surface-air stream, for drying the standing surface, flows continuously from the outlet element.

In a preferred configuration of the invention, it is provided that the toilet arrangement has at least one installation item for the interior construction of the toilet arrangement. The installation item is preferably in the form of a sanitary installation item or fixture. For example, the installation item is in the form of a washbasin module with a washbasin, with a water tap and with a placement surface, in the form of a toilet module with a toilet bowl, or in the form of a mirror with a placement surface. As an alternative or optionally in addition, the installation item is in the form of a cladding element. For example, the installation item is in the form of side wall cladding with a placement surface or in the form of a flooring element for cladding the base surface. Preferably, the toilet arrangement has multiple installation items, for example multiple sanitary installation items or fixtures and multiple cladding elements. The installation item is disposed within, in particular spatially within, the toilet arrangement. Furthermore, the standing surface is disposed on the at least one installation item. The standing surface is preferably disposed horizontally on the installation item. The at least one installation item has the at least one standing surface. Preferably, multiple standing surfaces are disposed on different installation items. The standing surface preferably, according to the installation item, differs in nature in terms of areal shape or areal extent. The surface-air stream flows onto the at least one installation item for the purpose of drying the standing surface. Consequently, the outlet element is directed towards the installation item. Preferably, the outlet element is disposed closely adjacent the installation item. Preferably, the outlet element adjoins the standing surface at the boundary thereof.

In a structural configuration of the invention, it is provided that the toilet arrangement has the at least one installation item, wherein the outlet element is connected to the installation item or is integrated in the installation item, wherein the outlet element and the standing surface are disposed adjacent one another. The outlet element has for example the slot-like or slit-like outlet opening, wherein the outlet element is integrated in the installation item in such a way that the outlet opening is formed as an opening in the installation item. In this way, merely the outlet opening, preferably in the form of a narrow slot or slit, of the outlet element is visible. The outlet opening is disposed adjacent the standing surface, preferably in a directly adjoining manner, with the result that the surface-air stream, after exiting, flows directly onto the standing surface for the purpose of drying. As an alternative, the outlet element is connected to the installation item such that, for example, the outlet opening is disposed at the boundary of the installation item, for example between two installation items. The outlet opening is preferably formed as a narrow slot or a narrow groove at the boundary of the installation item. This is particularly advantageous if an existing installation item is to be retrofitted to have a drying function.

In a preferred configuration of the invention, it is provided that the outlet element has a distribution channel with at least one outlet opening, wherein the distribution channel is connected to the ventilator for the purpose of areal distribution of the surface-air stream. The outlet element with the distribution channel is preferably integrated in the installation element. For example, the distribution channel extends peripherally around the standing surface within the installation item, wherein the at least one outlet opening is disposed outwardly towards the standing surface. The surface-air stream flows onto the standing surface from the at least one outlet opening for the purpose of drying. Preferably, the outlet element has multiple outlet openings, for example multiple slot-like outlet openings, wherein the multiple outlet openings together generate the surface-air stream. As an alternative, multiple outlet elements and/or multiple outlet openings generate multiple surface-air streams which together flow onto the standing surface for the purpose of drying. In this case, the surface-air streams do not need to flow onto the standing surface oriented in the same direction. For example, the surface-air streams flow onto the standing surface in opposite directions or in a crossing manner. It is advantageous if, by way of the distribution channel, provision is made for a surface-air stream for drying that extends areally and impinges onto the standing surface over the full area thereof, with the result that an optimal drying result is and/or can be produced.

In a particularly preferred configuration of the invention, it is provided that the toilet arrangement has the at least one installation item, wherein the installation item has a collecting channel for accumulating liquid, wherein the collecting channel is formed within the standing surface and/or is disposed on the installation item in a manner adjoining the standing surface. The collecting channel is preferably formed as a channel or as a groove in the installation item. For example, the installation item is in the form of a washbasin module, wherein the washbasin module has the collecting channel and the standing surface. These are disposed for example in a peripheral manner on a washbasin of the washbasin module. In particular in the case of relatively large quantities of liquid, puddle formation occurs on the standing surface, wherein the standing surface cannot be dried solely through evaporation. The collecting channel is preferably lower than the standing surface, wherein the liquid runs into the collecting channel, so that the liquid accumulates in the collecting channel and the puddle formation on the standing surface is and/or can be avoided. Preferably, the standing surface is formed so as to be inclined towards the collecting channel. Preferably, the standing surface has an inclination of at least 1.5 degrees, preferably of at least 3 degrees.

In a structural refinement of the invention, it is provided that the toilet arrangement has a wastewater interface for connection to a vacuum wastewater system of the aircraft, wherein the collecting channel is connected to the wastewater interface for drainage of the liquid. If, for example, a specific quantity of liquid is built up in the collecting channel, the liquid can be drawn into the vacuum wastewater system by opening of a valve of the wastewater interface. Preferably, the vacuum wastewater system is connected to the toilet arrangement for disposal of fecal matter, wherein blackwater is and/or can be sucked into a wastewater container by way of a negative pressure of the vacuum wastewater system. Preferably, upon actuation of a toilet flush, the liquid is extracted by suction from the collecting channel at the same time.

In a preferred configuration of the invention, it is provided that the at least one installation item is in the form of a toilet module or a washbasin module. These have the standing surface, wherein, in terms of its areal shape and areal extent, the standing surface of the toilet module may be formed differently from the standing surface of the washbasin module. For example, the standing surface is disposed on a toilet seat, a toilet lid or a toilet bowl of the toilet module. The surface-air stream flows for example over the closed toilet lid so that it is dried. For this purpose, for example, the outlet element is integrated in rear wall cladding of the toilet arrangement, wherein the surface-air stream flows onto the horizontal toilet lid from the rear wall cladding for the purpose of drying.

The washbasin module, as an installation item, has for example a washbasin with a washbasin boundary and/or a placement surface, wherein the standing surface is disposed on the washbasin boundary and/or on the placement surface. Optionally, the washbasin module has the collecting channel. Specifically during hand-washing, relatively large quantities of liquid can be deposited in the toilet arrangement and on the standing surfaces. The outlet element is integrated for example in the washbasin module and has an outlet opening along the washbasin boundary. As an alternative, the outlet opening is integrated in side wall cladding of the toilet arrangement, wherein the placement surface adjoins the side wall cladding. Preferably, the toilet arrangement has a paper towel dispenser which is disposed above the placement surface. For example, during hand-drying, liquid drips onto the placement surface situated therebelow. The surface-air stream flows, preferably continuously, onto the horizontal placement surface in order for the liquid to be evaporated and for the formation of odors to be avoided. It is advantageous if the outlet element can be disposed almost anywhere in the toilet arrangement, so that the surface-air stream impinges onto the installation item at the location where liquid frequently accumulates.

In a particularly preferred structural configuration of the invention, it is provided that the at least one installation item is in the form of a flooring installation for cladding a base surface in the toilet arrangement, wherein the standing surface is disposed on the flooring installation. Basically, the installation item, as described above, may be in the form of an arbitrary item, preferably a sanitary installation item, in the toilet arrangement. However, the base surface constitutes the region which comes into contact most frequently with, and with the greatest quantity of, liquid. In particular the splash water during use of the toilet module or of the washbasin module or during hand-drying causes the accumulation of liquid on the base surface. The flooring installation is preferably produced from a plastic material or a plastic/rubber mixture. The flooring installation preferably has one or more floor tiles which can be walked on by the passengers. For example, the floor tiles have the standing surface. The outlet element is preferably disposed close to the base in the toilet arrangement, so that the surface-air stream dries the floor tiles. It is advantageous if, by way of the drying function of the flooring installation, that the region of the toilet arrangement which is most frequently in contact with liquid is dried. It is moreover advantageous for the outlet element to be able to be disposed close to the base, and thus so as to be almost unnoticeable for a passenger. In this way, a toilet arrangement with a high level of comfort for the passengers is provided. It is moreover advantageous for the outlet element to be able to be extended over the entire width of the flooring installation, so that complete and gap-free drying of the standing surface is possible.

In a structural refinement of the invention, it is provided that the flooring installation has at least one trough portion and one base portion, wherein the trough portion is formed perpendicular to the base portion, wherein the trough portion has the outlet element and the base portion has the standing surface. The trough portion is preferably formed as a boundary-side wall. For example, the trough portion is disposed on two opposite boundaries of the flooring installation. The trough portion can also be regarded as skirting for the base portion. Preferably, the trough portion is connected to the base portion in a materially bonded manner, with the result that these are of single-part form. The base portion has the standing surface, with this preferably being of horizontal form. “Horizontal” is to be understood as meaning also a slight inclination of the base portion and/or of the standing surface for the running-off of liquid. Furthermore, proceeding from the trough portion, the surface-air stream flows onto the base portion from the outlet element in order to dry the standing surface of the flooring installation.

The outlet element is preferably integrated in the trough portion. Preferably, the outlet element has the distribution channel and the outlet opening, which are integrated together in the trough portion. The distribution channel is formed for example as a hollow tube along the vertical trough portion, wherein the one outlet opening or the multiple outlet openings are formed in the trough portion and are formed in the direction of the base portion. It is advantageous if, by way of the integration of the outlet element into the trough portion, the surface-air stream impinges onto the base portion, with the standing surface, particularly close thereto. If the outlet element has the distribution channel, it is moreover advantageous for the surface-air stream to be able to be distributed optimally, such that, for example, the standing surface is impinged upon completely by the surface-air stream, whereby the drying result is improved.

In a preferred refinement, it is provided that the base portion has the collecting channel for accumulating liquid. The collecting channel is disposed on the base portion at the boundary of the standing surface. Preferably, the collecting channel is disposed in such a way that it is disposed on the base portion opposite the outlet element. The collecting channel is preferably formed, for example by milling, as a groove in the base portion, with the result that the collecting channel is formed to be lower than the standing surface. The base portion preferably has an inclination in the direction of the collecting channel, with the result that the liquid automatically flows off into the collecting channel. Preferably, the surface-air stream can be oriented in such a way that it blows the liquid away from the base portion in the direction of the collecting channel. The collecting channel is preferably connected to the wastewater interface for drainage of the liquid, so that the built-up liquid can be suctioned into the vacuum wastewater system for disposal. It is advantageous for the surface-air stream to be configured not only for drying but also additionally for blowing-away of liquid on the standing surface. In particular in the case of relatively large quantities of liquid, for example more than 100 ml of a liquid, drying through evaporation can take a very long time, and so such quantities of liquid must be removed through the collecting channel from the standing surface or be disposed of from the toilet arrangement. The surface-air stream blows the liquid away from the standing surface into the collecting channel such that the bulk of the liquid is collected in the collecting channel, with residual moisture on the standing surface being evaporated by the surface-air stream.

In a preferred configuration of the invention, it is provided that the ventilator has a fan apparatus for compressing the cabin air. Basically, the ventilator can be operated passively by way of the pressure of the cabin air from the cabin ventilation system. In addition, it may be provided that the fan apparatus compresses the cabin air, so that the cabin air preferably has a higher pressure. In this way, the fan apparatus increases an air stream speed of the surface-air stream, wherein the surface-air stream is configured for blowing away liquid and for drying the standing surface. The fan apparatus generates active ventilation, so that the air stream speed of the surface-air stream can be increased. It is advantageous if, by way of the fan apparatus, control of the surface-air stream can be provided such that, for example in the case of the toilet arrangement being used to a great degree by the passengers, the air stream speed of the surface-air stream can be increased.

In a preferred configuration of the invention, it is provided that the ventilator has a heating element for thermally heating the cabin air. The heating element is preferably in the form of an electric heating element, in the form of a heat exchanger or in the form of a heat sink. The heating element is connected fluidically to the entry interface and to the outlet element such that the cabin air fed in is and/or can be guided to the heating element through the entry interface. The cabin air flows past the heating element for the purpose of heat exchange, wherein the heat-treated cabin air, in particular heated cabin air, is and/or can be discharged to the outlet element. Consequently, the surface-air stream, for drying the standing surface, is thermally heated and/or can be heated. The heated surface-air stream generated in this way, in relation to the untreated cabin air from the cabin ventilation system, preferably has a temperature difference of at least +3° C., preferably of at least +5° C., especially of at least +10° C. It is advantageous if, by way of the heated surface-air stream, an evaporation effect of liquids is promoted, so that provision is made for a toilet arrangement with a ventilator which dries standing surfaces in the toilet arrangement particularly quickly.

In order to heat the cabin air, different concepts for introduction of heat energy are conceivable. For example, the heating element is in the form of the electric heating element. The heating element preferably has heating wires which, through application of an electrical voltage, radiate heat energy, with the result that the cabin air flowing directly past is and/or can be heated. As an alternative, the heating element is in the form of the heat exchanger, wherein the heat exchanger takes over heat energy from a heat source, for example an electrical consumer, and/or exchanges heat energy with it.

It is however particularly preferably provided that the heating element is in the form of the heat sink. For example, the heat sink is connected to an electrical consumer, wherein the electrical consumer radiates and/or releases heat during operation. For example, the ventilator guides the cabin air, for heat exchange, along the electrical consumer, wherein the heat sink releases heat energy from the electrical consumer to the cabin air flowing past. An illumination device and/or a display in the toilet arrangement, for example integrated in a mirror, for heating the surface-air stream, may be used as the electrical consumer. In this respect, the ventilator guides the cabin air for example along and behind the mirror with the display, so that the cabin air is guided past the electrical consumer as close as possible thereto. The heat sink is for example in the form of a so-called heat pipe or in the form of a cooling body, in particular in the form of a metallic cooling body. During the removal of the heat energy through the heat sink, cooling is simultaneously provided for the electrical consumer, with the result that the latter is, for example, protected against overheating. It is advantageous if the waste heat from an electrical consumer can be used to heat the surface-air stream and to cool the electrical consumer. Output heat, for example from a display, which heat would simply be released to the ambient air, is thus able to be used in a targeted manner for heating the cabin air or the surface-air stream.

With the objects of the invention in view, there is also provided an aircraft having an aircraft cabin and having a cabin ventilation system for supplying the aircraft cabin with cabin air. The aircraft is preferably in the form of a passenger aircraft for passenger transportation. The aircraft cabin preferably has multiple passenger seats and/or rows of passenger seats, and also cabin monuments, for example a galley. The aircraft cabin has a toilet arrangement, also referred to as a lavatory, which is constructed as described above. The toilet arrangement is preferably constructed as a blockable sanitary installation. The toilet arrangement has the ventilator with the entry interface which is connected to the cabin ventilation system of the aircraft for take-over of cabin air. The ventilator is connected fluidically to the outlet element such that the cabin air flows from the outlet element as a surface-air stream. The surface-air stream flows, for the purpose of drying, onto the standing surface which is formed in the toilet arrangement. In principle, the standing surface may be disposed arbitrarily in the toilet arrangement. Preferably, the standing surface is formed on the flooring of the toilet arrangement.

With the objects of the invention in view, there is concomitantly provided a method for drying a standing surface in a toilet arrangement, wherein the toilet arrangement is constructed as described above. The aircraft has the cabin ventilation system for supplying the aircraft cabin with cabin air, wherein the at least one standing surface in the toilet arrangement is dried by a direct surface-air stream of extracted cabin air of the cabin ventilation system. For this purpose, it is provided that the cabin air is taken over from the cabin ventilation system through the entry interface of the ventilator, wherein the ventilator transfers the cabin air to the outlet element. The cabin air exits the outlet element as a surface-air stream, wherein the surface-air stream is directed over the standing surface by the outlet element. The standing surface is dried by the surface-air stream, wherein liquid on the standing surface evaporates. Preferably, the moist used air in the toilet arrangement is sucked in through exhaust-air nozzles. For example, the used air extracted by suction is fed to the cabin ventilation system for the purpose of reprocessing.

It is optionally provided for the method that, in a first operating state of the toilet arrangement, for example during use of the toilet arrangement by a passenger, the surface-air stream flows continuously onto the standing surface. In this case, the surface-air stream preferably flows at a low air stream speed onto the standing surface, so that the passenger does not perceive or only barely perceives the surface-air stream. Preferably, in a second operating state of the toilet arrangement, for example in an unused state, the air stream speed of the surface-air stream is increased for the purpose of intensifying the drying of the standing surface. In this case, no passenger is present in the toilet arrangement, and so a distinctly intense surface-air stream flows onto the standing surface for the purpose of drying or blowing-away. Preferably, the toilet arrangement has a control apparatus which controls the surface-air stream in the two operating states. For example, the ventilator has the fan apparatus, wherein the fan apparatus is connected electrically to the control apparatus. Preferably, a signal of the control apparatus is sent to the fan apparatus when the control apparatus detects the second operating state, that is to say an unused toilet arrangement, so that the fan apparatus increases the air stream speed of the surface-air stream for the purpose of intensifying the drying.

Other features which are considered as characteristic for the invention are set forth in the appended claims.

Although the invention is illustrated and described herein as embodied in a toilet arrangement for an aircraft cabin of an aircraft, an aircraft having the toilet arrangement and a method for drying a standing surface in the toilet arrangement, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a toilet arrangement for an aircraft cabin with multiple installation items as a preferred exemplary embodiment;

FIG. 2 is a highly diagrammatic, perspective view of the toilet arrangement with one of the installation items from FIG. 1 and with a ventilator as a preferred exemplary embodiment; and

FIG. 3 is a side-elevational view of the installation item from FIG. 2 as a flooring installation in a preferred exemplary embodiment.

### DETAILED DESCRIPTION OF THE INVENTION

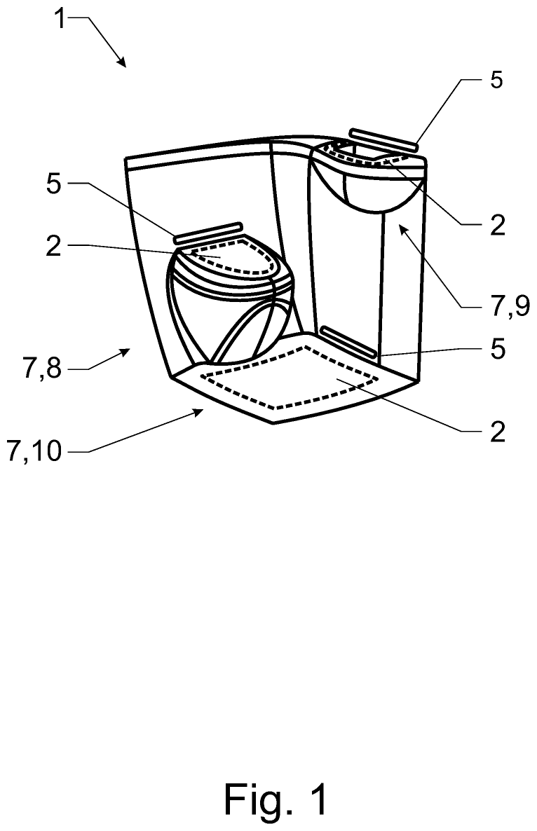

Referring now to the figures of the drawings in detail and first, particularly, to FIG. 1 thereof, there is seen a diagrammatic illustration of a toilet arrangement 1 in a preferred arrangement. In this case, merely a detail of the toilet arrangement 1 is shown, the latter being disposed in an aircraft cabin of an aircraft (not shown). Basically, the toilet arrangement 1 has multiple side walls, a rear wall, and a top and a base, wherein the toilet arrangement 1 can be entered through a door for passengers. The toilet arrangement 1 has multiple installation items 7 which, for example, are in the form of sanitary installation items or cladding elements. According to the exemplary embodiment in FIG. 1, the toilet arrangement has a toilet module 8, a washbasin module 9 and a flooring installation 10, as installation items 7.

The installation items 7 each have a standing surface 2, which are indicated by dashed lines on the installation items 7. The standing surfaces 2 are formed for the setting-down of items or persons, and so the standing surfaces 2 are disposed in a substantially horizontal manner on the installation items 7. Due to the horizontal arrangement of the standing surfaces 2, liquid can be deposited thereon. For example, standing moisture is formed on the standing surfaces 2 when the passengers use the toilet arrangement 1, for example the washbasin module 9 for washing hands. The liquids are in some cases responsible for the formation of unpleasant odors in the toilet arrangement 1 and for the quicker soiling of the toilet arrangement 1. This reduces the comfort of the passengers and also requires a greater cleaning effort for the toilet arrangement 1 by on-board or ground personnel.

The toilet arrangement 1 has multiple outlet elements 5. The outlet elements 5 are each assigned to a standing surface 2 and disposed adjacent thereto in the toilet arrangement 1. The outlet elements 5 are in the form of slot-like nozzles, wherein the outlet elements 5 are disposed in a manner adjoining the installation items 7 in the toilet arrangement 1. For example, these are integrated in an adjoining cladding part of the toilet arrangement 1. As an alternative or optionally in addition, the outlet element 5 is integrated in the installation item 7. For example, the washbasin module 9 has a placement surface, for example for placement of passengers' items, wherein the placement surface is in the form of a standing surface 2, wherein the outlet element 5 is integrated in the washbasin module 9 in such a way that it adjoins the placement surface or is formed within the placement surface.

The toilet arrangement 1 has a ventilator 3, which is connected to the outlet element 5. The ventilator 3 generates a surface-air stream 6 for the purpose of drying the standing surfaces 2. The surface-air stream 6 flows over the standing surface 2 close to the surface, whereby any liquid on the standing surface 2 is evaporated. The ventilator 3 for generating the surface-air stream 6 is shown in

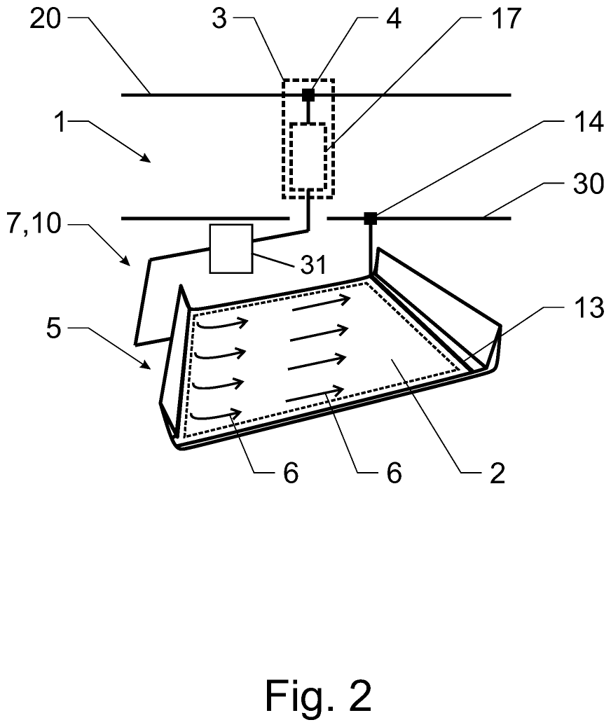

FIG. 2.

FIG. 2 shows, in a highly diagrammatic illustration, the toilet arrangement 1 with the ventilator 3, wherein, for the sake of clarity, merely one installation item 7 is shown. The installation item 7 is in the form of the flooring installation 10 and has the standing surface 2. The surface-air stream 6 is generated by the ventilator 3, wherein the ventilator 3 is connected to a cabin ventilation system 20 for ventilation and air-conditioning of the aircraft cabin. The ventilator 3 has an entry interface 4 for connecting to the cabin ventilation system 20. Cabin air, for example fresh air, can be extracted from the cabin ventilation system 20 through the entry interface 4. In FIG. 2, the cabin ventilation system 20, the ventilator 3 and the entry interface 4 are illustrated highly diagrammatically and in simplified form as lines for guiding the cabin air. The cabin air is taken over from the cabin ventilation system 20 through the entry interface 4, for example of an air-coupling device and/or a compressed-air connection, and fed to the ventilator 3. The ventilator 3 passes the cabin air, optionally through a heating element 31 for thermally heating the cabin air, on to the outlet element 5, wherein the surface-air stream 6 for drying the standing surface 2 is and/or can be generated from the cabin air. The ventilator 3 is constructed as a passive system, and so no additional ventilation of the cabin air is required. The ventilator 3 uses the existing pressure of the cabin ventilation system 20 to generate the surface-air stream 6. Optionally, the ventilator 3 has a fan apparatus 17. The fan apparatus 17 is constructed to compress the cabin air in order to increase an air stream speed of the surface-air stream 6. For example, in the case of relatively large quantities of liquid being detected on the flooring installation 10 or on the standing surface 2, for example by sensors in the flooring installation, it may be necessary to intensify the surface-air stream 6 so as to enhance drying action.

The standing surface 2 can be dried by the surface-air stream 6 in such a way that proceeding from the outlet element 5, the surface-air stream 6 flows over the standing surface 2. The outlet element 5 is integrated in the flooring installation 10. The outlet element 5 is formed beside the rectangular standing surface 2 at the boundary thereof. The outlet element 5 is formed over an entire side length of the standing surface 2, with the result that the surface-air stream 6 flows over the full area of the standing surface 2. The flooring installation 10 has a collecting channel 13, wherein the collecting channel 13 is disposed on the flooring installation 10 opposite the outlet element 5. The collecting channel 13 is formed as a channel and/or groove in the flooring installation 10 in a recessed manner. The collecting channel 13 collects relatively large quantities of liquid which, for example, do not evaporate directly. This liquid from the collecting channel 13 may be guided for example into a collecting container for disposal. Optionally, the collecting channel 13 is connected to a wastewater interface 14 for drainage of the liquid. The wastewater interface 14 is for example in the form of a valve, wherein the wastewater interface 14 is connected to a vacuum wastewater system 30. The vacuum wastewater system 30 is constructed for disposal of fecal matter, for example from the toilet module 8. For example, upon actuation of a toilet flush, extraction by suction, for example for a toilet bowl of the toilet module 8, is realized by way of a negative pressure of the vacuum wastewater system 30. The same result can occur, upon actuation of the toilet flush, with the liquid in the collecting channel 13. For example, the wastewater interface 14 is opened such that, by way of the negative pressure in the vacuum wastewater system 30, the liquid is extracted by suction from the collecting channel 13 and fed to the vacuum wastewater system 30 for disposal.

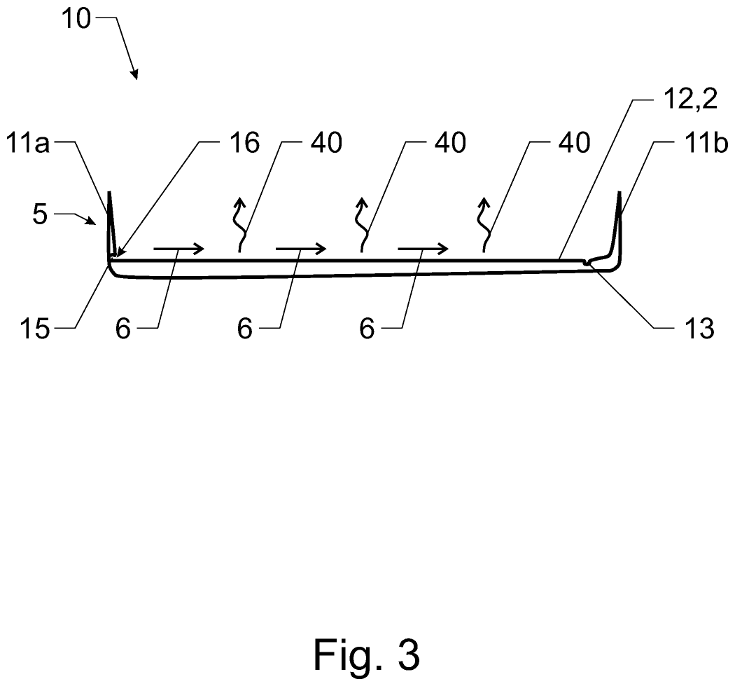

FIG. 3 shows the flooring installation 10 from FIG. 2 in a side view, wherein the flooring installation 10 has the standing surface 2 and the outlet element 5. According to the exemplary embodiment, the flooring installation 10 has a trough portion 11a and a further trough portion 11b, which are formed oppositely at the boundary of the flooring installation 10. The flooring installation 10 has a base portion 12, which is formed between the two trough portions 11a, 11b. The trough portions 11a, 11b are both formed perpendicular to the base portion 12. The base portion 12 has the standing surface 2, and the trough portion 11a has the outlet element 5. The trough portions 11a, 11b are in principle suitable for bordering the base portion 12 in a trough-like manner at the boundary thereof such that liquid on the base portion 12 stops and, for example, does not flow out of the toilet arrangement 1.

The outlet element 5 has a distribution channel 15 which is connected to the ventilator 3 for the purpose of taking over and distributing the cabin air. The distribution channel 15 is formed as a cutout or “thin” channel within the trough portion 11a. The distribution channel 15 is connected for example at an end and/or a face side of the trough portion 11a to the ventilator 3 for the purpose of taking over the cabin air. The outlet element 5 furthermore has an outlet opening 16, wherein the outlet opening 16 is connected to the distribution channel 15. The outlet opening 16 is formed towards the base portion 12 with the standing surface 2. The outlet opening 16 extends for example over the entire length or at least over most of the distribution channel 15, with the result that the surface-air stream 6 exiting the outlet opening 16 flows over the full area of the standing surface 2. The outlet opening 16 is in the form of a single-part continuous opening, wherein the outlet opening 16 has for example a total length of at least 50 cm. As an alternative, the outlet element 5 has multiple outlet openings 16 which are disposed in a line in an adjacent manner. For example, the multiple outlet openings 16 have a total length of at least 50 cm. It is conceivable for example that small webs within the outlet opening 16 divide it into multiple outlet openings 16. This may be carried out for example for reasons of the stability of the outlet element 5. The distribution channel 15 and the outlet opening 16 are disposed almost on a plane with the base section 12 or with the standing surface 2, with the result that the surface-air stream 6 flows over the latter close to the base. In the process, any liquid evaporates and rises as moist used air 40. The used air 40 can, for example, be extracted from the toilet arrangement 1 by the cabin ventilation system 20 through exhaust-air nozzles. The used air 40 is indicated in FIG. 3 as ascending wavy lines.

The flooring installation 10 has the collecting channel 13, wherein the collecting channel 13 is formed as a depression in the flooring installation 10. The collecting channel 13 is disposed on the base portion 12 opposite the outlet element 5. The collecting channel 13 is for example formed as a straight channel between the standing surface 2 and the further trough portion 11b. As an alternative, the collecting channel is disposed in a U shape, or in a manner passing peripherally around the standing surface 2, on the base portion 12. The collecting channel 13 is connected for example at an end to the wastewater interface 14 for disposal of the liquid. The surface-air stream 6 blows for example liquid on the standing surface 2 in the direction of the collecting channel 13. In this case, the surface-air stream 6 can be intensified by the fan apparatus 17 such that one part of the liquid evaporates as used air 40 and the remaining part of the liquid is blown into the collecting channel 13 for accumulation. In order to promote the running-off of the liquid into the collecting channel 13, the base portion 12 is formed so as to be inclined in the direction of the collecting channel.

### LIST OF REFERENCE SIGNS

1 Toilet arrangement
2 Standing surface
3 Ventilator
4 Entry interface
5 Outlet element
6 Surface-air stream
7 Installation item
8 Toilet module
9 Wash basin module
10 Flooring installation
11a Trough portion
11b Further trough portion
12 Base portion
13 Collecting channel
14 Wastewater interface
15 Distribution channel
16 Outlet opening
17 Fan apparatus
20 Cabin ventilation system
30 Vacuum wastewater system
31 Heating element

1. A toilet arrangement for an aircraft cabin of an aircraft having a cabin ventilation system for supplying the aircraft cabin with cabin air, the toilet arrangement comprising:
at least one standing surface cladding the toilet arrangement, said at least one standing surface disposed within the toilet arrangement;
a ventilator having an entry interface for connection to the cabin ventilation system for transfer of the cabin air; and
an outlet element connected to said entry interface for taking over the cabin air;
said ventilator generating a surface-air stream from the cabin air and causing the surface-air stream to flow over said standing surface from said outlet element for drying said at least one standing surface.

2. The toilet arrangement according to claim 1, wherein said at least one standing surface is formed horizontally in the toilet arrangement, permitting liquid to accumulate on said at least one standing surface, and the surface-air stream is configured to dry said at least one horizontally formed standing surface.

3. The toilet arrangement according to claim 1, which further comprises at least one installation item as an interior structure of the toilet arrangement, said at least one standing surface disposed on said at least one installation item, and the surface-air stream flowing onto said at least one installation item for drying said at least one standing surface.

4. The toilet arrangement according to claim 3, wherein said outlet element (5) is connected to said at least one installation item or is integrated in said at least one installation item, and said outlet element and said at least one standing surface (2) are disposed adjacent one another.

5. The toilet arrangement according to claim 1, wherein said outlet element has a distribution channel with at least one outlet opening, said distribution channel is connected to said ventilator for areal distribution of the surface-air stream, and the surface-air stream flows onto said at least one standing surface from said at least one outlet opening for drying said at least one standing surface.

6. The toilet arrangement according to claim 3, wherein said at least one installation item has a collecting channel for accumulating liquid, said collecting channel is at least one of formed within said at least one standing surface or disposed on said at least one installation item adjoining said at least one standing surface.

7. The toilet arrangement according to claim 6, which further comprises a wastewater interface for connection to a vacuum wastewater system of the aircraft, said collecting channel being connected to said wastewater interface for drainage of the accumulating liquid.

8. The toilet arrangement according to claim 3, wherein said at least one installation item is a toilet module or a washbasin module.

9. The toilet arrangement according to claim 6, wherein said at least one installation item is a flooring installation for cladding a base surface in the toilet arrangement, and said at least one standing surface is disposed on said flooring installation.

10. The toilet arrangement according to claim 9, wherein:
said flooring installation has at least one trough portion and one base portion;
said at least one trough portion is perpendicular to said base portion;
said at least one trough portion has said outlet element;
said base portion has said at least one standing surface; and
the surface-air stream proceeds from said at least one trough portion and flows from said outlet element against said base portion to dry said at least one standing surface of said flooring installation.

11. The toilet arrangement according to claim 10, wherein said base portion has said collecting channel for accumulating liquid, and said collecting channel is disposed on said base portion at a boundary of said at least one standing surface.

12. The toilet arrangement according to claim 1, wherein said ventilator has a fan apparatus for compressing the cabin air, said fan apparatus increases an air stream speed of the surface-air stream, causing the surface-air stream to blow away liquid and dry said at least one standing surface.

13. The toilet arrangement according to claim 1, wherein said ventilator has a heating element for thermally heating the cabin air, and said heating element is connected fluidically to said entry interface and to said outlet element, causing the cabin air to flow past said heating element for heat exchange, resulting in thermally heating the surface-air stream for drying said at least one standing surface.

14. An aircraft, comprising:
an aircraft cabin having a toilet arrangement according to claim 1; and
a cabin ventilation system for supplying the aircraft cabin with cabin air.

15. A method for drying a standing surface in a toilet arrangement of an aircraft, the method comprising:
providing an aircraft having an aircraft cabin and a cabin ventilation system for supplying the aircraft cabin with cabin air;
providing the aircraft with a toilet arrangement having a standing surface according to claim 1; and
drying the standing surface in the toilet arrangement by using a direct surface-air stream of extracted cabin air of the cabin ventilation system.
